(19) United States
(12) Patent Application Publication
(10) Pub. No.: US 2016/0372832 A1
(43) Pub. Date: Dec. 22, 2016

(54) ARRAY ANTENNA AND RADAR SYSTEM FOR VEHICLES HAVING THE SAME

(71) Applicant: MANDO Corporation, Pyeongtaek-si (KR)

(72) Inventors: Yong Jai PARK, Hwaseong-si (KR); Hyung Suk HAM, Yongin-si (KR)

(21) Appl. No.: 15/172,151

(22) Filed: Jun. 3, 2016

(30) Foreign Application Priority Data
Jun. 17, 2015 (KR) 10-2015-0085948

(51) Int. Cl. H01Q 13/20; G01S 13/93; G01S 13/04; H01Q 1/32

(52) U.S. Cl. CPC H01Q 13/20; H01Q 1/3233; G01S 13/931; G01S 13/04

(57) ABSTRACT

The present disclosure relates to an array antenna including at least: a power supply unit; a power supply line consecutively bent in the longitudinal direction, and connected to the power supply unit; and a plurality of radiation devices consecutively arranged to be spaced apart from each other in the longitudinal direction of the power supply line. The present disclosure also relates to a radar system for vehicles having an array antenna, including at least: a power supply unit; a power supply line extended to have a predetermined length; a plurality of radiation devices consecutively arranged in the longitudinal direction of the power supply line, and installed to be slanted with respect to the longitudinal central axis line of the power supply line in order to have directivity in the polarized direction; and a controller detecting objects near a vehicle by using the transmitted and received signals.

### CROSS REFERENCE TO RELATED APPLICATION

This application claims priority from Korean Patent Application No. 10-2015-0085948, filed on Jun. 17, 2015, which is hereby incorporated by reference for all purposes as if fully set forth herein.

### BACKGROUND OF THE INVENTION

1. Field of the invention

The present embodiment relates to an array antenna and a radar system for vehicles having the same, and more particularly, to an array antenna and a radar system for vehicles having the same in which radiation devices are arranged to be slanted in the polarized direction to have directivity in order to thereby minimize signal interference with the oncoming vehicles due to the polarization effect so that the performance of the frequency transmission and reception may be improved.

2. Description of the Prior Art

In general, a radar system for vehicles, which is an essential technique in implementing intelligent transportation systems, has been developed in order to prevent accidents, which may occur due to severe weather conditions or driver negligence, by sensing the movement of other vehicles or objects within a several hundred meter radius.

The conventional radar system for vehicles uses a method for detecting objects in front of the vehicle within a limited range by using an array antenna that has a high gain in order to obtain the high spatial resolution in a small detection angle.

However, the conventional array antenna may generate signal interference with respect to oncoming vehicles due to the polarization effect, which may cause an operational malfunction in the driving of a system.

Therefore, the present embodiment provides an array antenna that can secure the optimum polarization transmission/reception performance with a simple structure and that can discretionally adjust the line width between the radiation devices while arranging the radiation devices in a straight line.

The prior reference related to the present embodiment is Korean Patent Publication No. 10-2012-0012617 (10 Feb. 2012) that discloses a micro strip antenna of a radar system for vehicles.

### SUMMARY OF THE INVENTION

The object of the present embodiment is to provide an array antenna and a radar system for vehicles having the same in which radiation devices are disposed to be slanted in the polarized direction to have directivity in order to thereby minimize signal interference with the oncoming vehicles due to the polarization effect so that the performance of the frequency transmission and reception may be improved

In addition, another object of the present embodiment is to provide a radar system for vehicles that can reduce non-uniformity of the amount of current supplied to the radiation devices by arranging the radiation devices such that the thickness of the radiation device gradually decreases in the opposite direction of a matching unit.

An array antenna, according to the embodiment, may include: a power supply unit configured to be supplied with a current from a current supply unit; a power supply line configured to be consecutively bent in the longitudinal direction, and configured to be connected to the power supply unit at one end thereof; and a plurality of radiation devices configured to be consecutively arranged to be spaced apart from each other in the longitudinal direction of the power supply line.

Here, a matching unit may be further connected to the other end of the power supply line, which is the opposite end of the one end to which the power supply unit is connected, and the matching unit may perform a function of radiating a current.

In addition, the power supply line may be extended to be bent in a pattern of a straight line or a curve.

In addition, the power supply line may be extended to be bent in a zigzag pattern at a right angle or a tilt angle in the longitudinal direction.

In addition, the bent points of the power supply line may be formed in a curve along the bent direction and the radiation devices may be consecutively disposed between the bent points.

In addition, the power supply line may have: a first connection portion configured to be connected to one end of the radiation device at the same tilt angle; a bent portion configured to be connected to one end of the first connection portion, and configured to be extended to be bent in a zigzag pattern at a right angle or a tilt angle in the longitudinal direction; and a second connection portion configured to be connected between one end of the bent portion, and configured to be connected to one end of the radiation device at the same tilt angle.

In addition, the radiation devices may be installed to be slanted with respect to the longitudinal central axis line of the power supply line in order to have directivity in the polarized direction and the radiation devices may be formed to be slanted in the same direction in order to form polarization of the same direction.

In addition, the thickness of the radiation device may remain constant, or vary consecutively or at each position in the longitudinal direction of the power supply line.

Meanwhile, a radar system for vehicles having an array antenna may include: a power supply unit configured to be supplied with a current from a current supply unit; a power supply line configured to be extended to have a predetermined length, and configured to be connected to the power supply unit at one end thereof; a plurality of radiation devices configured to be consecutively arranged in the longitudinal direction of the power supply line, and configured to be installed to be slanted with respect to the longitudinal central axis line of the power supply line in order to have directivity in the polarized direction; and a controller configured to transmit signals through the radiation devices and the power supply line, configured to receive the signals that are reflected by surrounding objects, and configured to detect objects near a vehicle by using the transmitted and received signals.

Here, a matching unit may be further connected to the other end of the power supply line, which is the opposite end of the one end to which the power supply unit is connected, and the matching unit may perform a function of radiating a current.

In addition, the controller may include: a signal transmitting and receiving unit configured to transmit signals through the radiation devices and the power supply line, and configured to receive the signals that are reflected by surrounding objects; and a signal processing unit configured to detect objects near the vehicle by using the transmitted and received signals from the signal transmitting and receiving unit.

The present embodiment may dispose the radiation device to be slanted in the polarized direction to have directivity in order to thereby minimize signal interference for the oncoming vehicles due to the polarization effect so that the performance of the frequency transmission and reception may be improved

In addition, the present embodiment may form the power supply line to be consecutively bent in order to thereby easily position the radiation devices on the same line, and may discretionally adjust the line width between the radiation devices in order to thereby secure the freedom of design.

In addition, the present embodiment may allow the thickness of the radiation device to gradually increase or decrease in the opposite position of the matching unit in order to thereby transfer a current to the radiation devices according to specific current distribution.

### BRIEF DESCRIPTION OF THE DRAWINGS

The above and other objects, features, and advantages of the present invention will be more apparent from the following detailed description taken in conjunction with the accompanying drawings, in which:

FIG. 1 is a front view showing an array antenna, according to the present embodiment;

FIG. 2 is a view for showing a pattern in which the thickness of the radiation device of the array antenna gradually varies, according to the present embodiment;

FIG. 3 is a front view showing the state in which a bent portion of a power supply line is formed to be slanted in the array antenna, according to the present embodiment; and

FIG. 4 is a view showing a radar system for vehicles having an array antenna, according to the present embodiment.

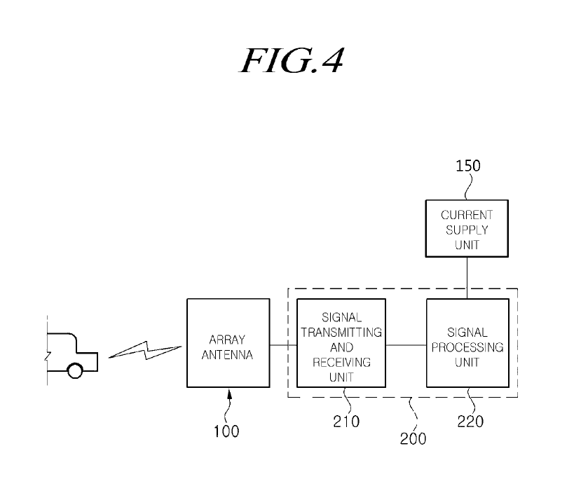

### DETAILED DESCRIPTION OF THE EXEMPLARY EMBODIMENTS

Hereinafter, embodiments will be described in detail with reference to the accompanying drawings.

The advantages and features of the present invention and methods of achieving the same will be apparent by referring to embodiments of the present invention as described below in detail in conjunction with the accompanying drawings.

However, the technical idea of present invention is not limited to the embodiments set forth below, but may be implemented in various different forms. The following embodiments are provided only to completely disclose the present invention and inform those skilled in the art of the scope of the present invention, and the present invention is defined only by the scope of the appended claims.

Further, in describing embodiments of the present invention, a detailed description of known technologies incorporated herein will be omitted when it may make the subject matter of the present invention rather unclear.

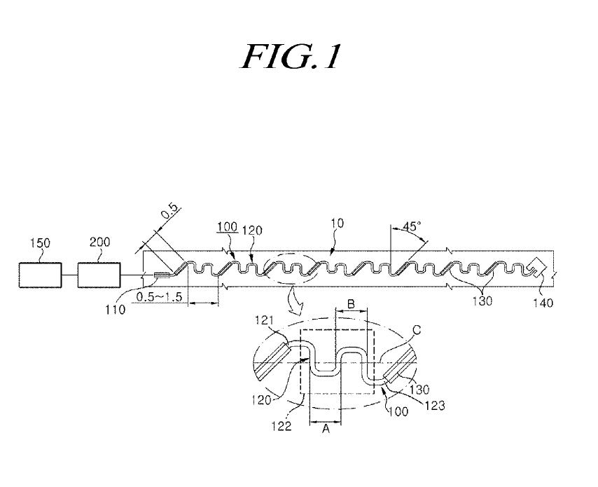

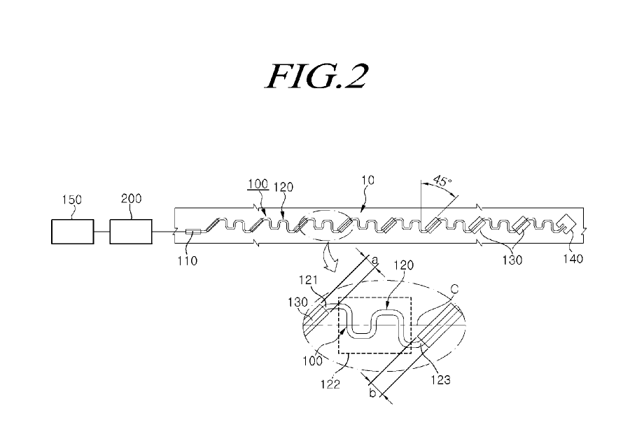

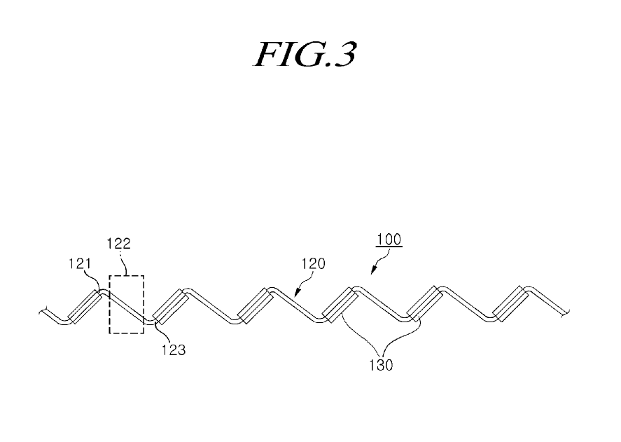

FIG. 1 is a front view showing an array antenna, according to the present embodiment, and FIG. 2 is a view for showing a pattern in which the thickness of the radiation device of the array antenna gradually varies, according to the present embodiment. FIG. 3 is a front view showing the state in which a bent portion of a power supply line is formed to be slanted in the array antenna, according to the present embodiment.

As shown in FIGS. 1 and 3, the array antenna 100 may include a power supply unit 110, a power supply line 120, radiation devices 130, and a matching unit 140.

The array antenna 100 is applied to a radar system installed in a vehicle, and is installed on the board 10 in order to thereby transmit and receive polarized waves (traveling waves or standing waves).

The power supply unit 110 is electrically connected with a current supply unit 150 installed in the vehicle in order to thereby supply a current to the radiation devices 130 as shown in FIGS. 1 and 2.

Furthermore, the power supply unit 110 may be electrically connected to a signal transmitting and receiving unit 210 of the controller 200, which will be described later in FIG. 2.

The power supply line 120 is extended to have a predetermined length, and the power supply unit 110 is connected to one end of the power supply line 120 in a longitudinal direction.

Here, the matching unit 140 is selectively connected to the other end of the power supply line 120, which is an end opposite to the end to which the power supply unit 110 is connected. In some cases, the connection of the matching unit 140 may not be necessary.

The matching unit 140 may radiate the current supplied from the power supply line 120, and may simultaneously perform a matching function. Hereinafter, the longitudinal direction means a lengthwise direction of the power supply line. Furthermore, the power supply line may be understood as a transmission line. The matching function refers to a function of completely radiating the current supplied to the end of the power supply line, and thus, the current may be prevented from being reflected at the end of the power supply line to return to the power supply unit 110.

In addition, the power supply line 120 is extended to be continuously bent in the longitudinal direction, and the radiation devices 130, which will be described later, are consecutively arranged in the longitudinal direction of the power supply line 120.

In addition, the power supply line 120 may be extended to be bent in various patterns, such as a straight line or a curve, in the longitudinal direction.

For example, the power supply line 120 may have a bent zigzag pattern, and the power supply line 120 may be bent at a right angle as shown in FIGS. 1 and 2.

At this time, the bent portions (A and B) of the power supply line 120 may have the same width as shown in FIG. 1.

Alternatively, the power supply line 120 may be formed to have a first connection portion 121, a bent portion 122, and a second connection portion 123, as shown in FIG. 1.

The first connection portion 121 is connected to one end of the radiation device 130 at the same tilt angle, and bent portion 122 is connected to one end of the first connection portion 121 to be extended in a zigzag pattern at a right angle or a tilt angle along the longitudinal direction. In addition, the second connection portion 123 is connected between one end of the bent portion 122 and one end of another radiation device 130 at the same tilt angle.

Here, one or more bent portions 122 may be provided, which are bent to have a right angle or a tilt angle, and the number of bends may vary depending on usage.

In addition, the first connection portion 121 and the second connection portion 123 may be connected to the ends of the radiation devices 130 to be slanted, respectively, wherein the first connection portion 121 and the second connection portion 123 may be in a line.

In addition, the bent portion 122 may be formed between the first connection portion 121 and the second connection portion 123, wherein the first connection portion 121 and the second connection portion 123 may be parallel to each other.

Furthermore, the power supply line 120 may be diagonally bent to have a tilt angle as shown in FIG. 3.

If the power supply line 120 is diagonally bent, the connection length between the radiation devices 130 may be minimized in order to thereby prevent loss, and the current offset effect may be lowered, which occurs when the line is formed to be a meander line.

Furthermore, the bent points of the power supply line 120 may be formed in a curve along the bent direction, and the radiation devices 130 to be described later may be consecutively disposed between the bent points.

At this time, the radiation devices 130, which will be described later, may be continuously formed on the power supply line 120 in the bent direction.

Here, the bent pattern of the power supply line 120 is not limited to the embodiment above, and the power supply line 120 may be formed in a various shape.

Since the power supply line 120 described above has a continuously bent pattern, the space between the radiation devices 130 may be adjusted as necessary.

The radiation devices 130 are arranged to be spaced a predetermined distance apart from each other in the longitudinal direction of the power supply line 120 in order to thereby transmit and receive radio waves.

Here, the radiation devices 130 may radiate traveling waves or standing waves, and may be installed to be slanted at a specific angle with respect to the longitudinal central axis line (C) of the power supply line 120 in order to configure the polarized direction.

More specifically, the radiation devices 130 may be arranged in a straight line along the longitudinal direction of the power supply line 120.

In addition, the radiation devices 130 may be installed to be slanted at a specific angle with respect to the longitudinal central axis line (C) of the power supply line 120 in order to have directivity in the polarized direction.

In this case, the radiation devices 130 may be formed to be inclined at the same angle so as to form the same polarized direction.

For example, the radiation devices 130 may be installed at a specific angle θ (for example, 45°) to conform to the polarized direction as shown in FIGS. 1 and 2.

In addition, the radiation devices 130 may have the same angle, or may be installed at different angles as necessary (not shown).

In addition, the distance between the radiation devices 130 may be in the range of 0.5 to 1.5λ as shown in FIG. 1, but may be variously configured. For example, the distance between the radiation devices 130 may be determined according to the wavelength of radiation signals that are radiated from the radiation devices 130. For example, the radiation devices 130 may be arranged 0.5λ, 1λ, or 1.5λ apart from each other.

Furthermore, the radiation devices 130 may be formed to be slanted with a length of 0.5 λg, but the length of the radiation device 130 may be variously configured as necessary.

In addition, the thicknesses (a and b) of the radiation devices 130 may consecutively vary along the longitudinal direction of the power supply line 120, and current distribution may be discretionally adjusted by configuring the thickness to be different (for example, it may decease and then increase). That is, distribution of the transmission power may be discretionally adjusted according to the current distribution.

For example, the thicknesses (a and b) of the radiation devices 130 may gradually decrease, or increase, along the longitudinal direction of the power supply line 120 as shown in FIG. 2.

The configuring of the thicknesses of the radiation devices 130 to be different is intended to supply relatively a large amount of current to the radiation device 130 that is positioned close to the power supply source so that the current can be uniformly transferred to the terminal radiation device 130.

That is, the radiation device 130 positioned close to the power supply unit 110 may be formed to be thicker so that the degree of power supply of the radiation device 130, which is positioned in the opposite direction of the power supply unit 110, can remain constant.

Meanwhile, a plurality of impedance transmission lines (not shown) may be arranged on one side of the radiation devices 130.

The impedance transmission lines may be disposed between the radiation devices 130 where the power supply lines 120 are positioned, or may be disposed on the contact points between the power supply lines 120 and the radiation devices 130.

The matching unit 140 may be installed at the end of the power supply line 120 in the opposite direction, and may radiate the remaining current while performing a matching function.

Here, the matching unit 140 may be arranged in a line to have the same angle as the radiation device 130, which is disposed at a specific angle along the power supply line 120, as shown FIGS. 1 and 2.

A single array antenna 100 may be provided as shown in FIGS. 1 to 3, or a plurality of array antennas 100 may be arranged in parallel.

Hereinafter, the radar system for vehicles having an array antenna, according to another embodiment, will be described, and the description of the same configuration as the configuration described above will be omitted.

As shown in FIG. 3, the radar system for vehicles having an array antenna, according to another embodiment, may include the power supply unit 110, the power supply line 120, the radiation devices 130, the matching unit 140, and a controller 200.

The controller 200 transmits signals through the radiation devices 130 and the power supply line 120, and receives the signals that are reflected by surrounding objects.

At this time, the controller 200 may analyze the transmission and reception signals in order to thereby detect objects near the vehicle or in order to thereby calculate information, such as a distance.

To this end, the controller 200 may include a signal transmitting and receiving unit 210 that transmits signals through the radiation devices 130 and the power supply line 120, and that receives the signals that are reflected by surrounding objects.

In addition, a signal processing unit 220 may be adopted, which detects objects near the vehicle by using the transmission and reception signals from the signal transmitting and receiving unit 210.

As a result, the present embodiment may dispose the radiation devices to be slanted in the polarized direction to have directivity in order to thereby minimize signal interference for the oncoming vehicles by the polarization effect so that the performance of the frequency transmission and reception may be improved

In addition, a plurality of power supply lines may be formed to be bent so that the radiation devices 130 can be easily positioned on the same line.

In addition, the thicknesses of the radiation devices, which are arranged in the opposite direction of the power supply unit 110, may gradually decrease in order to thereby transfer a uniform current to the radiation devices 130.

Furthermore, the power supply line 120 may be formed to be bent so that the line width between the radiation devices 130 can be discretionally adjusted in order to thereby secure freedom of design.

Although the array antenna and the radar system for vehicles having the same, according to the present embodiment, have been described in detail, it is obvious that the embodiment may be variously modified without departing from the scope of the present embodiment.

Therefore, the scope of the present invention should not be limited to the aforementioned embodiments, but should be defined by the equivalents to the appended claims as well as the claims.

Accordingly, it should be understood that the above-described embodiments are merely exemplary and is not limited, and it should be interpreted that the scope of the present invention is represented by the claims rather than the description, and the changes or modifications derived from the claims and the equivalents thereof pertain to the scope of the present invention.

What is claimed is:

1. An array antenna comprising:
a power supply unit configured to be supplied with a current from a current supply unit;
a power supply line configured to be consecutively bent in the longitudinal direction, and configured to be connected to the power supply unit at one end thereof; and
a plurality of radiation devices configured to be consecutively arranged to be spaced apart from each other in the longitudinal direction of the power supply line.

2. The array antenna according to claim 1, wherein a matching unit is further connected to the other end of the power supply line, which is the opposite end of the one end to which the power supply unit is connected, and the matching unit performs a function of radiating a current.

3. The array antenna according to claim 1, wherein the power supply line is extended to be bent in a pattern of a straight line or a curve.

4. The array antenna according to claim 3, wherein the power supply line is extended to be bent in a zigzag pattern at a right angle or a tilt angle in the longitudinal direction.

5. The array antenna according to claim 1, wherein the bent points of the power supply line are formed in a curve along the bent direction and the radiation devices are consecutively disposed between the bent points.

6. The array antenna according to claim 1, wherein the power supply line has:
a first connection portion configured to be connected to one end of the radiation device at the same tilt angle;
a bent portion configured to be connected to one end of the first connection portion, and configured to be extended to be bent in a zigzag pattern at a right angle or a tilt angle in the longitudinal direction; and
a second connection portion configured to be connected between one end of the bent portion, and configured to be connected to one end of the radiation device at the same tilt angle.

7. The array antenna according to claim 1, wherein the radiation devices are installed to be slanted with respect to the longitudinal central axis line of the power supply line in order to have directivity in the polarized direction and the radiation devices are formed to be slanted in the same direction in order to form polarization of the same direction.

8. The array antenna according to claim 1, wherein the thickness of the radiation device remains, or vary consecutively or at each position in the longitudinal direction of the power supply line.

9. The array antenna according to claim 1, wherein the radiation devices are consecutively arranged to be spaced the same distance apart from each other and the same distance is determined according to the wavelength of a signal radiated by the radiation device.

10. A radar system for vehicles having an array antenna, the radar system comprising:
a power supply unit configured to be supplied with a current from a current supply unit;
a power supply line configured to be extended to have a predetermined length, and configured to have the power supply unit that is connected to one end thereof;
a plurality of radiation devices configured to be consecutively arranged in the longitudinal direction of the power supply line, and configured to be installed to be slanted with respect to the longitudinal central axis line of the power supply line in order to have directivity in the polarized direction; and
a controller configured to transmit signals through the radiation devices and the power supply line, to receive the signals that are reflected by surrounding objects, and to detect objects near a vehicle by using the transmitted and received signals.

11. The radar system for vehicles according to claim 10, wherein a matching unit is further connected to the other end of the power supply line, which is the opposite end of the one end to which the power supply unit is connected, and the matching unit performs a function of radiating a current.

12. The radar system for vehicles according to claim 10, wherein the controller includes:
a signal transmitting and receiving unit configured to transmit signals through the radiation devices and the power supply line, and configured to receive the signals that are reflected by surrounding objects; and
a signal processing unit configured to detect objects near the vehicle by using the transmitted and received signals from the signal transmitting and receiving unit.
